(19) United States
(12) Patent Application Publication
(10) Pub. No.: US 2024/0119844 A1
(43) Pub. Date: Apr. 11, 2024

(54) AIR CURRENT OBSERVATION DEVICE, AIR CURRENT OBSERVATION SYSTEM, AND AIR CURRENT OBSERVATION METHOD

(71) Applicant: NEC Corporation, Minato-ku, Tokyo (JP)

(72) Inventor: Katsuhiro Yutani, Tokyo (JP)

(73) Assignee: NEC Corporation, Minato-ku, Tokyo (JP)

(21) Appl. No.: 18/275,888

(22) PCT Filed: Feb. 17, 2021
(86) PCT No.: PCT/JP2021/005963

§ 371 Date: Aug. 4, 2023

(51) Int. Cl. G08G 5/00

(52) U.S. Cl. CPC G08G 5/0004; G08G 5/0034

(57) ABSTRACT

The purpose of the present invention is to provide an air current observation device by which it is possible to secure, with greater ease, a power source resource and a communication resource. An air current observation device (3) comprises: an air current detection means (21) by which an optical sensing device (2) installed on a tower-like structure (1) emits a laser beam to an aerial area surrounding the tower-like structure (1), and that, when the optical sensing device (2) receives reflected light from the laser beam, generates air current information pertaining to an air current in the aerial area on the basis of the laser beam and the reflected light; and an air current map generation means (22) that generates an air current map indicating the distribution of air current in the aerial area using the air current information.

### TECHNICAL FIELD

The present disclosure relates to an air current observation device, and the like.

### BACKGROUND ART

PTL 1 discloses a technique of observing an air current in the sky by using light detection and ranging (LiDAR). In the technique described in PTL 1, as one example of LiDAR, a remote air current measurement device installed in an aircraft is used for observation of an air current. Specifically, the remote air current measurement device installed in the aircraft transmits laser light for LiDAR, and receives reflected light. Thus, an air current is observed based on a principle of Doppler LiDAR. More specifically, a two-dimensional air current distribution is acquired (see paragraphs to [0035], FIGS. 1 and 2, and the like in PTL 1).

Note that, as a related technique, a technique described in PTL 2 is also known.

### CITATION LIST

### Patent Literature

PTL 1: Japanese Unexamined Patent Application Publication No. 2017-067680
PTL 2: Japanese Unexamined Patent Application Publication No. 2002-214346

### SUMMARY OF INVENTION

### Technical Problem

As described above, the technique described in PTL 1 is observing an air current in the sky by using a remote air current measurement device installed in an aircraft. Generally, in an aircraft, various resources (e.g., a power source resource and a communication resource) for a device to be installed are limited. Therefore, in the technique described in PTL 1, there is a problem that it may be difficult to secure a power source resource and a communication resource for air current observation. The present disclosure has been made in order to solve the problem as described above, and an object of the present disclosure is to provide an air current observation device and the like that are capable of more easily securing a power source resource and a communication resource.

### Solution to Problem

One aspect of an air current observation device according to the present disclosure includes: an air current detection means for generating, when an optical sensing device installed in a tower-like structure irradiates an aerial area in a periphery of the tower-like structure with laser light, and the optical sensing device receives reflected light corresponding to the laser light, air current information relating to an air current in the aerial area, based on the laser light and the reflected light; and an air current map generation means for generating an air current map indicating a distribution of the air current in the aerial area by using the air current information.

One aspect of an air current observation system according to the present disclosure includes: an air current detection means for generating, when an optical sensing device installed in a tower-like structure irradiates an aerial area in a periphery of the tower-like structure with laser light, and the optical sensing device receives reflected light corresponding to the laser light, air current information relating to an air current in the aerial area, based on the laser light and the reflected light; and an air current map generation means for generating an air current map indicating a distribution of the air current in the aerial area by using the air current information.

One aspect of an air current observation method according to the present disclosure includes: generating, by an air current detection means, when an optical sensing device installed in a tower-like structure irradiates an aerial area in a periphery of the tower-like structure with laser light, and the optical sensing device receives reflected light corresponding to the laser light, air current information relating to an air current in the aerial area, based on the laser light and the reflected light; and generating, by an air current map generation means, an air current map indicating a distribution of the air current in the aerial area by using the air current information.

### Advantageous Effects of Invention

According to the present disclosure, a power source resource and a communication resource can be more easily secured.

### BRIEF DESCRIPTION OF DRAWINGS

FIG. 1 is an explanatory diagram illustrating an example of a state in which a plurality of optical sensing devices are installed in a plurality of tower-like structures.

FIG. 2 is a block diagram illustrating an essential part of an air current observation system according to a first example embodiment.

FIG. 3 is a block diagram illustrating an essential part of an individual optical sensing device in the air current observation system according to the first example embodiment.

FIG. 4 is a block diagram illustrating an essential part of an air current observation device according to the first example embodiment.

FIG. 5 is a block diagram illustrating a hardware configuration of an essential part of the air current observation device according to the first example embodiment.

FIG. 6 is a block diagram illustrating another hardware configuration of an essential part of the air current observation device according to the first example embodiment.

FIG. 7 is a block diagram illustrating another hardware configuration of an essential part of the air current observation device according to the first example embodiment.

FIG. 8 is a flowchart illustrating an operation of the air current observation device according to the first example embodiment.

FIG. 9 is a block diagram illustrating an essential part of another air current observation device according to the first example embodiment.

FIG. 10 is a block diagram illustrating an essential part of another air current observation system according to the first example embodiment.

FIG. 11 is a block diagram illustrating an essential part of another air current observation device according to the first example embodiment.

FIG. 12 is a block diagram illustrating an essential part of another air current observation device according to the first example embodiment.

FIG. 13 is a block diagram illustrating an essential part of another air current observation system according to the first example embodiment.

### EXAMPLE EMBODIMENT

Hereinafter, an example embodiment according to the present disclosure is explained in detail with reference to the accompanying drawings.

### First Example Embodiment

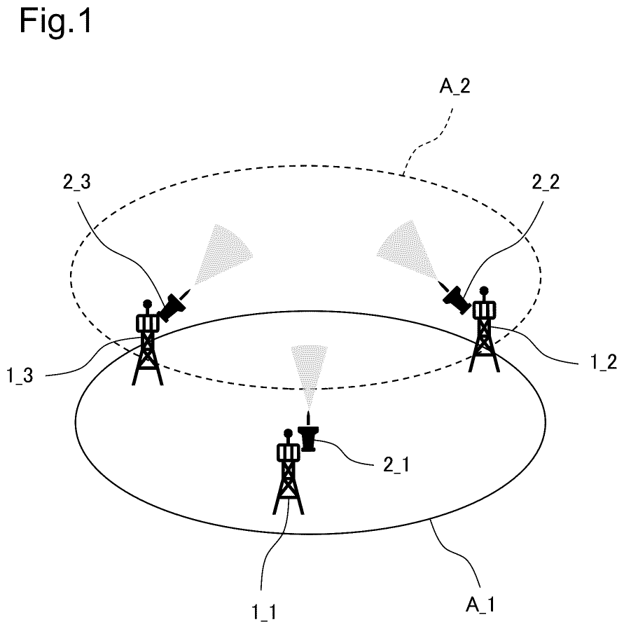

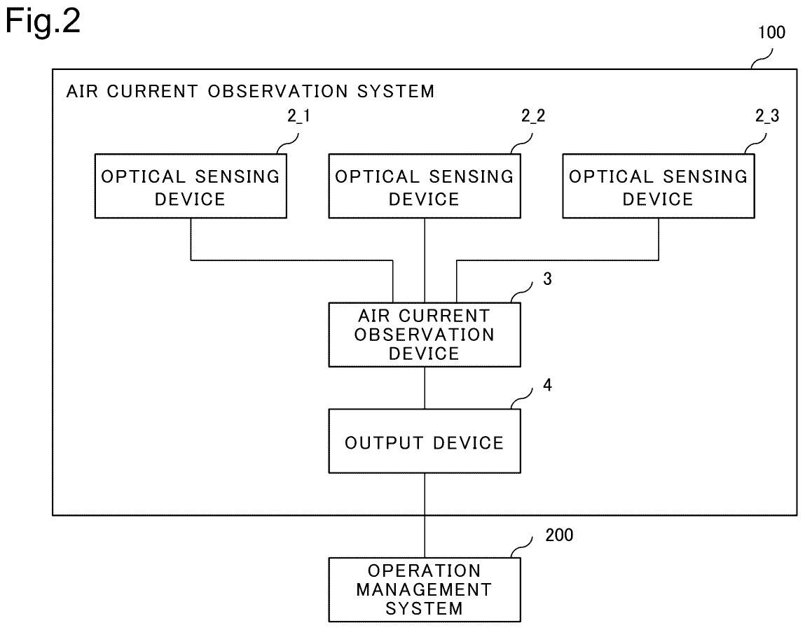

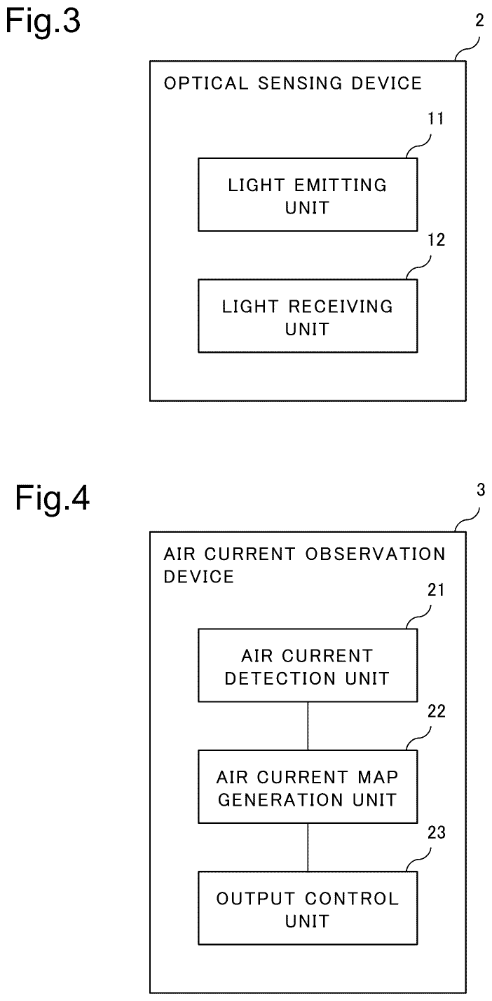

FIG. 1 is an explanatory diagram illustrating an example of a state in which a plurality of optical sensing devices are installed in a plurality of tower-like structures. FIG. 2 is a block diagram illustrating an essential part of an air current observation system according to a first example embodiment. FIG. 3 is a block diagram illustrating an essential part of an individual optical sensing device in the air current observation system according to the first example embodiment. FIG. 4 is a block diagram illustrating an essential part of an air current observation device according to the first example embodiment. The air current observation device according to the first example embodiment is explained with reference to FIGS. 1 to 4.

As illustrated in FIG. 1, N tower-like structures (hereinafter, referred to as “tower-like structures”) 1_1 to 1_N are provided. Further, N optical sensing devices 2_1 to 2_N are provided in the N tower-like structures 1_1 to 1_N. Herein, N is an integer of 2 or more. In the example illustrated in FIGS. 1 and 2, N=3.

In the individual tower-like structure 1, a facility for wireless communication or a facility for wired communication (hereinafter, generically referred to as a “communication facility”) is provided. Alternatively, the individual tower-like structure 1 is constituted of a communication facility. Specifically, for example, a communication base station is provided in the individual tower-like structure 1. Alternatively, for example, the individual tower-like structure 1 is constituted of a communication steel tower. Hereinafter, explanation is made mainly based on an example of a case in which a communication base station is provided in the individual tower-like structure 1.

Herein, a communication facility in the individual tower-like structure 1 is connected to a power network. Therefore, a communication facility in the individual tower-like structure 1 includes a power source in which electric power to be supplied from the power network is used. An individual optical sensing device 2 is operated by using electric power to be supplied from a power source of a communication facility in the associated tower-like structure 1. In other words, the individual optical sensing device 2 is connected to a power source network via a communication facility in the associated tower-like structure 1.

Further, a communication facility in the individual tower-like structure 1 is included in a communication network by wireless communication or wired communication. When the individual optical sensing device 2 communicates with another device (e.g., an air current observation device 3 to be described later) by wireless communication or wired communication, a communication facility in the associated tower-like structure 1 is used. In other words, the individual optical sensing device 2 is connected to the communication network via a communication facility in the associated tower-like structure 1.

In FIG. 1, A_1 indicates an area (hereinafter, referred to as a “ground area”) including installation positions of the tower-like structures 1_1 to 1_N on the ground. In contrast, A_2 indicates an area in the sky (hereinafter, referred to as an “aerial area”) with respect to the ground area A_1. Specifically, the aerial area A_2 is an area in a periphery of the tower-like structures 1_1 to 1_N in the sky.

Herein, a height of the aerial area A_2 with respect to the ground area A_1 may be different according to usage of an air current observation system 100. A specific example of usage of the air current observation system 100 is described later. Further, the aerial area A_2 may be an area having a width in a height direction. In other words, the aerial area A_2 may be a three-dimensional area.

As illustrated in FIG. 2, the air current observation system 100 includes the optical sensing devices 2_1 to 2_N, the air current observation device 3, and an output device 4. As illustrated in FIG. 3, the individual optical sensing device 2 includes a light emitting unit 11 and a light receiving unit 12. As illustrated in FIG. 4, the air current observation device 3 includes an air current detection unit 21, an air current map generation unit 22, and an output control unit 23.

As described above, the individual optical sensing device 2 is installed in the associated tower-like structure 1. The individual optical sensing device 2 is installed toward the aerial area A_2. Further, the individual optical sensing device 2 is operated by using a power source of a communication facility in the associated tower-like structure 1. Further, the individual optical sensing device 2 is freely communicable with the air current observation device 3 by using a communication facility in the associated tower-like structure 1.

The light emitting unit 11 is, for example, a unit using a laser light source. The light emitting unit 11 emits pulsed laser light. Herein, in the individual optical sensing device 2, an emitting direction of laser light by the light emitting unit 11 is variable. Thus, the light emitting unit 11 successively emits laser light in a plurality of directions. Consequently, laser light is applied in such a way as to scan the aerial area A_2.

The applied laser light is reflected as scattered light by fine particles (hereinafter, referred to as “aerosol particles”) floating in the aerial area A_2. The aerosol particles include, for example, dust. Hereinafter, the reflected light may also be referred to as “reflected light”. The light receiving unit 12 receives reflected light. The light receiving unit 12 is, for example, a unit using a light receiving element. The air current detection unit 21 generates information (hereinafter, referred to as “air current information”) relating to an air current in the aerial area A_2, based on laser light to be emitted by the light emitting unit 11 of the individual optical sensing device 2, and reflected light received by the light receiving unit 12 of the associated optical sensing device 2. The air current map generation unit 22 generates a map (hereinafter, referred to as an “air current map”) indicating a distribution of an air current in the aerial area A_2 by using the generated air current information. Generation of air current information and generation of an air current map are based on the principle of Doppler LiDAR.

Specifically, the air current detection unit 21 acquires information indicating a frequency component included in laser light to be emitted by the light emitting unit 11 of the individual optical sensing device 2. Further, the air current detection unit 21 acquires information indicating a frequency component included in reflected light received by the light receiving unit 12 of the individual optical sensing device 2, the reflected light corresponding to laser light emitted in each direction. These pieces of information are acquired, for example, from the individual optical sensing device 2. These pieces of information can be said to be based on the laser light to be emitted as described above, and the reflected light received as described above.

The air current detection unit 21 computes a Doppler shift amount in reflected light corresponding to laser light emitted by the individual optical sensing device 2 in each direction by using these pieces of information. In other words, the air current detection unit 21 computes the Doppler shift amount, based on the laser light to be emitted as described above and the reflected light received as described above. The Doppler shift amount to be computed is based on a frequency of laser light to be emitted by the individual optical sensing device 2. Specifically, the Doppler shift amount to be computed is based on a difference between a frequency component included in laser light emitted by the individual optical sensing device 2 in each direction, and a frequency component included in associated reflected light.

The air current detection unit 21 computes a value (hereinafter, referred to as a “wind direction value”) indicating a wind direction in each predetermined range in the aerial area A_2 by using the computed Doppler shift amount. Further, the air current detection unit 21 computes a value (hereinafter, referred to as a “wind velocity value”) indicating a wind velocity in each predetermined range in the aerial area A_2 by using the computed Doppler shift amount.

Specifically, for example, the air current detection unit 21 computes a Doppler velocity with respect to each direction of line of sight for the individual optical sensing device 2, and in a so-called “direction of line of sight” by using the computed Doppler shift amount described above. The air current detection unit 21 computes a wind vector v in each predetermined range by using the computed Doppler velocity. For computation of the wind vector v, for example, a velocity azimuth display (VAD) method is employed. An orientation of the computed wind vector v is corresponding to a wind direction value. Further, a magnitude of the computed wind vector v is corresponding to a wind velocity value.

The air current detection unit 21 generates information (specifically, air current information) including the computed wind direction value and the computed wind velocity value. The air current map generation unit 22 generates a map (specifically, an air current map) indicating a distribution of the wind vector v in the aerial area A_2 by using the generated air current information.

Herein, as described above, the N optical sensing devices 2_1 to 2_N are provided in the N tower-like structures 1_1 to 1_N. Using the plurality of optical sensing devices 2 allows the air current map generation unit 22 to generate a three-dimensional air current map in the three-dimensional aerial area A_2. Note that, generation of air current information and generation of an air current map may be based on the principle of three-dimensional scanning type Doppler LiDAR.

In addition to the above, for generation of air current information and generation of an air current map, various known techniques relating to Doppler LiDAR can be employed. Detailed explanation regarding these techniques is omitted.

The output control unit 23 performs control of outputting information (hereinafter, referred to as “air current map information”) including an air current map generated by the air current map generation unit 22. The output device 4 is used for output of the air current map information. The output device 4 includes, for example, at least one of a display device and a communication device. The display device includes, for example, a display. The communication device includes, for example, a dedicated transmitter and receiver.

Specifically, for example, the output control unit 23 performs control of displaying an image corresponding to air current map information. A display device among the output device 4 is used for display of the image. Alternatively, for example, the output control unit 23 performs control of transmitting a signal corresponding to air current map information. A communication device among the output device 4 is used for transmission of the signal.

In this way, an essential part of the air current observation system 100 is configured.

Hereinafter, explanation is made mainly based on an example of a case in which the output device 4 includes a communication device. A signal corresponding to air current map information is transmitted to an operation management system 200 by the output device 4. Specifically, the air current map information is output to the operation management system 200 by the output device 4 (see FIG. 2).

The operation management system 200 is a system for managing an operation of a plurality of flying objects (e.g., drones for logistics). The air current map information is used for computation of a route (hereinafter, referred to as a “recommended flight route”) suitable for flight by an individual flying object in the aerial area A_2. Specifically, for example, the operation management system 200 detects an occurrence position of turbulence in the aerial area A_2, based on an air current map included in the air current map information. The route computation unit 24 computes a recommended flight route by computing a route in which the occurrence position of turbulence is avoided among routes from a departure point to a destination in the aerial area A_2.

In this case, usage of the air current map information (specifically, usage of the air current observation system 100) is computation of a recommended flight route. Therefore, a height of the aerial area A_2 with respect to the ground area A_1 is set to a value according to an altitude at which a flying object (e.g., a drone for logistics) can fly. Generally, the range of the altitude is restricted by performance of a flying object. Further, the range of the altitude is regulated by laws in a district including the ground area A_1.

Note that, the operation management system 200 may compute a plurality of recommended flight routes, and compute a value (hereinafter, referred to as a “degree of recommendation”) indicating a degree by which an individual recommended flight route is recommended. The degree of recommendation is computed, for example, based on a flight time to be predicted, a flight distance to be predicted, or battery consumption to be predicted.

Further, the operation management system 200 may compute a recommended flight route in an area (hereinafter, referred to as a “flight recommended area”) being acquired by excluding, from the aerial area A_2, an area not being suitable for flight of a flying object. Herein, the flight recommended area is an area being set in advance, based on laws, information relating to an obstacle in the aerial area A_2, and the like.

Further, the operation management system 200 may compute a route (hereinafter, referred to as an “avoidance recommended route”) for which avoidance in a flight recommended area is recommended, based on an air current map included in the air current map information, in addition to computing a recommended flight route. The avoidance recommended route is, for example, a route passing an occurrence position of turbulence as described above.

Hereinafter, the light emitting unit 11 may also be referred to as a “light emitting means”. Further, the light receiving unit 12 may also be referred to as a “light receiving means”. Further, the air current detection unit 21 may also be referred to as an “air current detection means”. Further, the air current map generation unit 22 may also be referred to as an “air current map generation means”. Further, the output control unit 23 may also be referred to as an “output control means”.

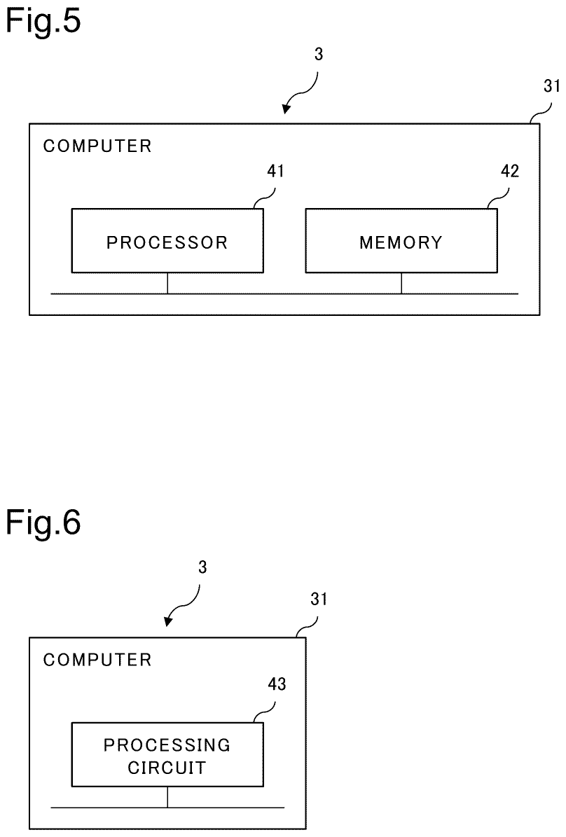

Next, a hardware configuration of an essential part of the air current observation device 3 is explained with reference to FIGS. 5 to 7.

As illustrated in FIGS. 5 to 7, the air current observation device 3 is a device using a computer 31. The computer 31 is freely communicable with the individual optical sensing device 2. The computer 31 may be provided in a cloud network.

As illustrated in FIG. 5, the computer 31 includes a processor 41 and a memory 42. The memory 42 stores a program for causing the computer 31 to function as the air current detection unit 21, the air current map generation unit 22, and the output control unit 23. The processor 41 reads and executes the program stored in the memory 42. This achieves a function F1 of the air current detection unit 21, a function F2 of the air current map generation unit 22, and a function F3 of the output control unit 23.

Alternatively, as illustrated in FIG. 6, the computer 31 includes a processing circuit 43. The processing circuit 43 performs processing for causing the computer 31 to function as the air current detection unit 21, the air current map generation unit 22, and the output control unit 23. This achieves the functions F1 to F3.

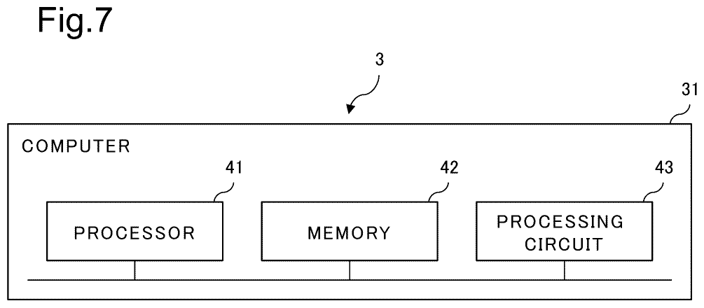

Alternatively, as illustrated in FIG. 7, the computer 31 includes the processor 41, the memory 42, and the processing circuit 43. In this case, a part of the functions F1 to F3 is achieved by the processor 41 and the memory 42, and remaining functions among the functions F1 to F3 are achieved by the processing circuit 43.

The processor 41 is constituted of one or more processors. The individual processor is a processor using, for example, a central processing unit (CPU), a graphics processing unit (GPU), a microprocessor, a microcontroller, or a digital signal processor (DSP).

The memory 42 is constituted of one or more memories. The individual memory is a memory using, for example, a random access memory (RAM), a read only memory (ROM), a flash memory, an erasable programmable read only memory (EPROM), an electrically erasable programmable read only memory (EEPROM), a solid-state drive, a hard disk drive, a flexible disk, a compact disc, a digital versatile disc (DVD), a Blu-ray disc, a magneto optical (MO) disk, or a mini disc.

The processing circuit 43 is constituted of one or more processing circuits. The individual processing circuit is, for example, a circuit using an application specific integrated circuit (ASIC), a programmable logic device (PLD), a field programmable gate array (FPGA), a system on a chip (SoC), or a system large scale integration (LSI).

Note that, the processor 41 may include a dedicated processor corresponding to each of the functions F1 to F3. The memory 42 may include a dedicated memory corresponding to each of the functions F1 to F3. The processing circuit 43 may include a dedicated processing circuit corresponding to each of the functions F1 to F3.

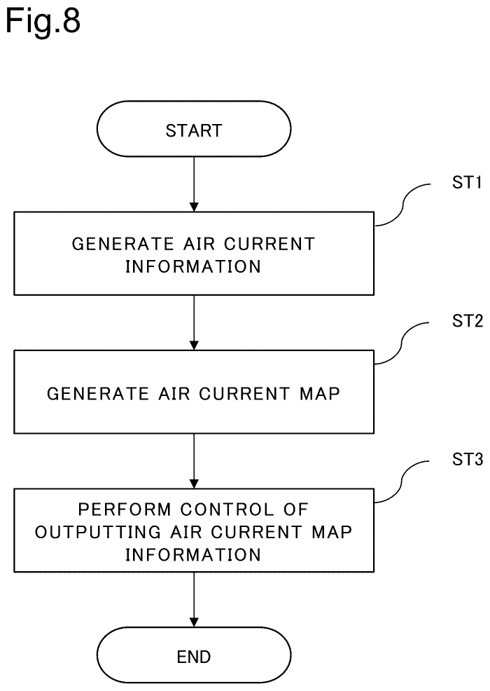

Next, an operation of the air current observation device 3 is explained with reference to a flowchart illustrated in FIG. 8.

First, the air current detection unit 21 generates air current information (step ST1). Subsequently, the air current map generation unit 22 generates an air current map (step ST2). As described above, generation of air current information and generation of an air current map are based on the principle of Doppler LiDAR. Further, the air current information generated in step ST1 is used for generation of an air current map in step ST2. Subsequently, the output control unit 23 performs control of outputting information (specifically, air current map information) including the generated air current map (step ST3).

Next, an advantageous effect by using the air current observation system 100 is explained.

As described above, in the air current observation system 100, the individual optical sensing device 2 is provided in the associated tower-like structure 1. Generally, securing various resources for a device to be installed in the individual tower-like structure 1 is easy, as compared with securing the resources for a device to be installed in an aircraft. Therefore, for example, securing a power source resource and a communication resource for the individual optical sensing device 2 is easy, as compared with securing a power source resource and a communication resource for a remote air current measurement device in the technique described in PTL 1.

Specifically, as described above, the individual optical sensing device 2 can be operated by using electric power to be supplied from a power source of a communication facility in the associated tower-like structure 1. In other words, the individual optical sensing device 2 can be connected to a power source network via a communication facility in the associated tower-like structure 1. Consequently, a power source resource can be easily secured, as compared with a case (specifically, a case of using the technique described in PTL 1) in which the optical sensing device 2 is provisionally installed in an aircraft.

Further, as described above, when the individual optical sensing device 2 communicates with another device (e.g., the air current observation device 3) by wireless communication or wired communication, it is possible to use a communication facility in the associated tower-like structure 1. In other words, the individual optical sensing device 2 can be connected to a communication network via a communication facility in the associated tower-like structure 1. Consequently, a communication resource can be easily secured, as compared with a case (specifically, a case of using the technique described in PTL 1) in which the optical sensing device 2 is provisionally installed in an aircraft.

In particular, connecting the individual optical sensing device 2 to a communication network via a communication facility in the associated tower-like structure 1 enables to achieve high-speed data transmission from the individual optical sensing device 2 to another device (e.g., the air current observation device 3). Further, the individual optical sensing device 2 can be used as an Internet of things (IoT) terminal.

Further, generally, a communication facility (particularly, a communication base station) is disposed in a district (particularly, an urban area) including residence of people at a substantially fixed interval. Using the optical sensing device 2 provided in the associated tower-like structure 1 for these communication facilities enables to achieve observation of an air current in the aerial area A_2 corresponding to the district.

Next, a modification example of the air current observation system 100 is explained.

An air current observation device 3 may include N air current detection units 21 corresponding to N optical sensing devices 2_1 to 2_N by one-to-one. The individual air current detection unit 21 may be integrally provided with the associated optical sensing device 2. In this case, the communication network as described above may be used for transmission of air current information from the individual air current detection unit 21 to an air current map generation unit 22.

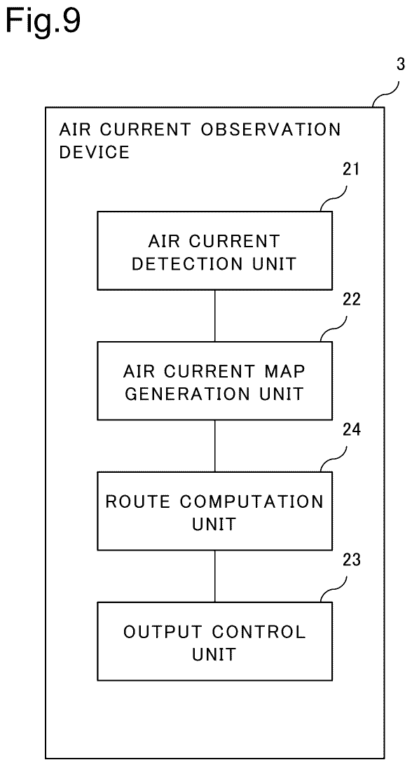

Next, another modification example of the air current observation system 100 is explained by using FIG. 9.

An air current observation device 3 may include a part of functions included in the operation management system 200. For example, as illustrated in FIG. 9, the air current observation device 3 may include a route computation unit 24. Hereinafter, the route computation unit 24 may also be referred to as a “route computation means”. The route computation unit 24 computes a recommended flight route for a flying object (e.g., a drone for logistics), based on an air current map generated by an air current map generation unit 22.

Specifically, for example, the route computation unit 24 detects an occurrence position of turbulence in an aerial area A_2, based on the computed air current map described above. The route computation unit 24 computes a recommended flight route by computing a route in which the occurrence position of turbulence is avoided among routes from a departure point to a destination in the aerial area A_2.

An output control unit 23 performs control of outputting information (hereinafter, referred to as “recommended flight route information”) indicating the computed recommended flight route described above, in place of or in addition to control of outputting air current map information. The recommended flight route information is output to the operation management system 200 by an output device 4. The recommended flight route information is used for operation management of a flying object by the operation management system 200.

Note that, the route computation unit 24 may compute a plurality of recommended flight routes, and compute a degree of recommendation corresponding to the individual recommended flight route. The recommended flight route information may be information including information indicating an individual recommended flight route, and information indicating a degree of recommendation corresponding to the individual recommended flight route.

Further, the route computation unit 24 may compute a recommended flight route in a flight recommended area among the aerial area A_2.

Further, the route computation unit 24 may compute an avoidance recommended route, based on the air current map generated by the air current map generation unit 22, in addition to computing a recommended flight route. The avoidance recommended route is, for example, a route passing the occurrence position of turbulence as described above. In this case, the output control unit 23 may perform control of outputting information (hereinafter, referred to as “avoidance recommended route information”) indicating the computed avoidance recommended route. The avoidance recommended route information is output to the operation management system 200 by the output device 4. The avoidance recommended route information is used for operation management of a flying object by the operation management system 200.

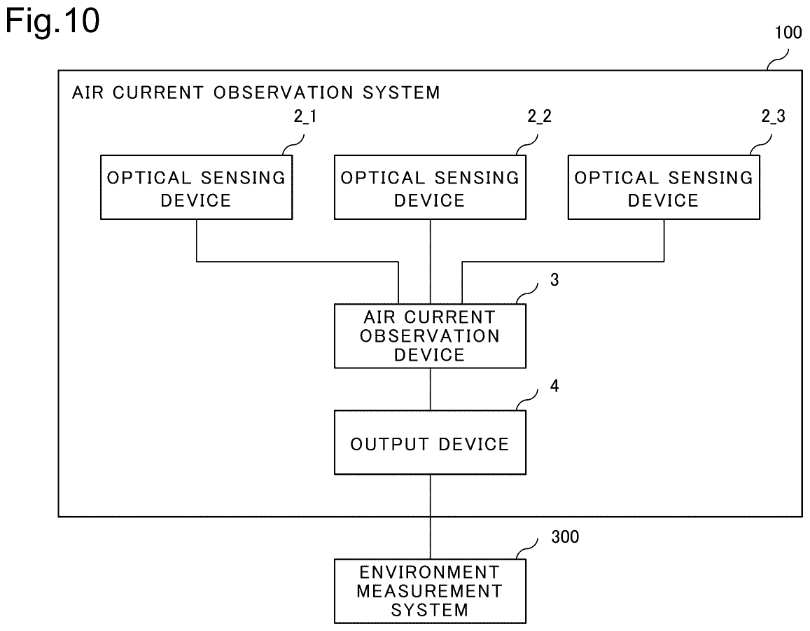

Next, another modification example of the air current observation system 100 is explained with reference to FIG. 10.

Usage of air current map information (specifically, usage of the air current observation system 100) is not limited to recommended flight route computation. For example, as illustrated in FIG. 10, an output device 4 may output air current map information to an environment measurement system 300. The environment measurement system 300 is a system for measuring an atmospheric environment in an aerial area A_2. The environment measurement system 300 uses air current map information for the measurement.

Specifically, for example, it is assumed that a distribution of an air current in the aerial area A_2 is included in a measurement target by the environment measurement system 300. In this case, the environment measurement system 300 uses air current map information being output by the air current observation system 100, as a result of the measurement.

Alternatively, for example, it is assumed that prediction of diffusion of a predetermined substance (e.g., nitrogen oxide) in the aerial area A_2 is included in a measurement target by the environment measurement system 300. In this case, the environment measurement system 300 acquires information indicating a distribution of the substance in the present or in the past in the aerial area A_2. The environment measurement system 300 predicts diffusion of the substance by using an air current map included in the air current map information, based on a distribution indicated by the information.

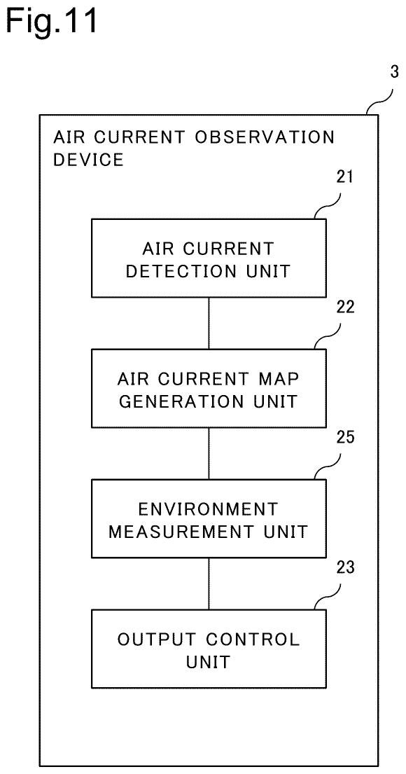

Next, another modification example of the air current observation system 100 is explained with reference to FIG. 11.

An air current observation device 3 may include a part of functions included in the environment measurement system 300. For example, as illustrated in FIG. 11, the air current observation device 3 may include an environment measurement unit 25. Hereinafter, the environment measurement unit 25 may also be referred to as an “environment measurement means”. The environment measurement unit 25 measures an atmospheric environment in an aerial area A_2. The environment measurement unit 25 uses an air current map for the measurement.

Specifically, for example, it is assumed that a distribution of an air current in the aerial area A_2 is included in a measurement target by the environment measurement unit 25. In this case, the environment measurement unit 25 uses an air current map generated by an air current map generation unit 22, as a result of the measurement.

Alternatively, for example, it is assumed that prediction of diffusion of a predetermined substance (e.g., nitrogen oxide) in the aerial area A_2 is included in a measurement target by the environment measurement unit 25. In this case, the environment measurement unit 25 acquires information indicating a distribution of the substance in the present or in the past in the aerial area A_2. The environment measurement unit 25 predicts diffusion of the substance by using the generated air current map described above, based on a distribution indicated by the information.

An output control unit 23 performs control of outputting information (hereinafter, referred to as “atmospheric environment information”) including a result of measurement by the environment measurement unit 25, in place of or in addition to control of outputting air current map information.

Next, another modification example of the air current observation system 100 is explained.

An air current map is not limited to a three-dimensional map. The air current map may be a two-dimensional map. In this case, the air current observation system 100 may include at least one optical sensing device 2. Specifically, the air current observation system 100 may include one optical sensing device 2, in place of N optical sensing devices 2_1 to 2_N.

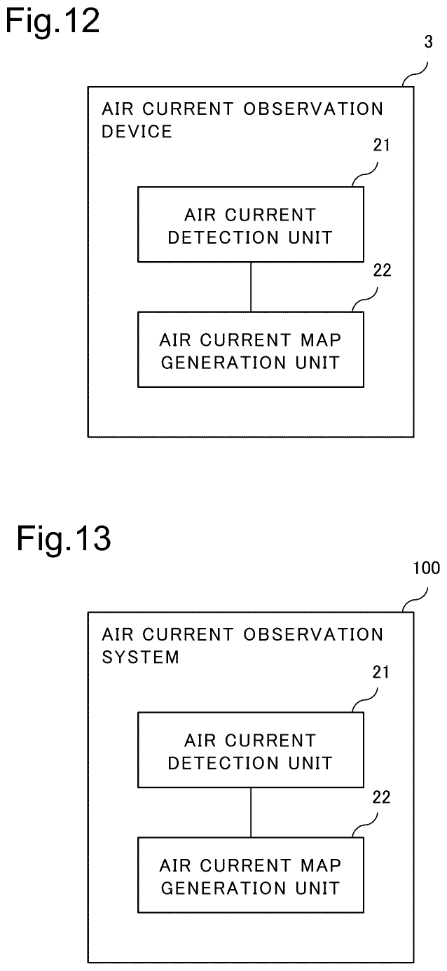

Next, a modification example of the air current observation device 3 is explained with reference to FIG. 12. Further, another modification example of the air current observation system 100 is explained with reference to FIG. 13.

As illustrated in FIG. 12, the air current observation device 3 may include an air current detection unit 21 and an air current map generation unit 22. In other words, an essential part of the air current observation device 3 may be constituted of the air current detection unit 21 and the air current map generation unit 22. In this case, an output control unit 23 may be provided outside the air current observation device 3.

As illustrated in FIG. 13, the air current observation system 100 may include an air current detection unit 21 and an air current map generation unit 22. In other words, an essential part of the air current observation system 100 may be constituted of the air current detection unit 21 and the air current map generation unit 22. In this case, an optical sensing device 2 may be provided outside the air current observation system 100. Further, an output control unit 23 may be provided outside the air current observation system 100. Further, an output device 4 may be provided outside the air current observation system 100. Note that, in the air current observation system 100, each of the air current detection unit 21 and the air current map generation unit 22 may be constituted of an independent device.

Also in these cases, the advantageous effect as described above is acquired. Specifically, the optical sensing device 2 (not illustrated in FIGS. 12 and 13) installed in the tower-like structure 1 irradiates the aerial area A_2 in the periphery of the tower-like structure 1 with laser light, and the optical sensing device 2 receives reflected light corresponding to the laser light. At this occasion, the air current detection unit 21 generates air current information relating to an air current in the aerial area A_2, based on the laser light and the reflected light. The air current map generation unit 22 generates an air current map indicating a distribution of the air current in the aerial area A_2 by using the air current information. Using the optical sensing device 2 installed in the tower-like structure 1 makes it easy to secure various resources. More specifically, securing a power source resource and a communication resource can be made easy, as compared with a case (specifically, a case of using the technique described in PTL 1) in which the optical sensing device 2 to be installed in an aircraft is provisionally used.

While the present disclosure has been particularly shown and described with reference to exemplary embodiments thereof, the present disclosure is not limited to these embodiments. It will be understood by those of ordinary skill in the art that various changes in form and details may be made therein without departing from the spirt and scope of the present disclosure as defined by the claims.

A part or all of the above-described example embodiment may also be described as the following supplementary notes, but is not limited to the following.

### [Supplementary Note]

[Supplementary Note 1]

An air current observation device including:
an air current detection means for generating, when an optical sensing device installed in a tower-like structure irradiates an aerial area in a periphery of the tower-like structure with laser light, and the optical sensing device receives reflected light corresponding to the laser light, air current information relating to an air current in the aerial area, based on the laser light and the reflected light; and
an air current map generation means for generating an air current map indicating a distribution of the air current in the aerial area by using the air current information.

[Supplementary Note 2]

The air current observation device according to supplementary note 1, wherein the air current detection means generates the air current information by detecting a wind direction and a wind velocity in the aerial area, based on a difference between a frequency component included in the laser light and a frequency component included in the reflected light.

[Supplementary Note 3]

The air current observation device according to supplementary note 1 or 2, wherein
the optical sensing device is installed in each of a plurality of the tower-like structures, and
the air current map generation means generates the air current map of a three-dimensional shape by using the air current information.

[Supplementary Note 4]

The air current observation device according to any one of supplementary notes 1 to 3, further including an output control means for outputting information including the air current map.

[Supplementary Note 5]

The air current observation device according to supplementary note 4, wherein the information including the air current map is output to an operation management system of a flying object, and used for computation of a recommended flight route in the aerial area.

[Supplementary Note 6]

The air current observation device according to supplementary note 4, wherein the information including the air current map is output to an environment measurement system, and used for measurement of an atmospheric environment in the aerial area.

[Supplementary Note 7]

The air current observation device according to any one of supplementary notes 1 to 3, further including:
a route computation means for computing a recommended flight route of a flying object in the aerial area by using the air current map; and
an output control means for outputting information including the recommended flight route.

[Supplementary Note 8]

The air current observation device according to any one of supplementary notes 1 to 3, further including:
an environment measurement means for measuring an atmospheric environment in the aerial area by using the air current map; and
an output control means for outputting information including a result of measurement by the environment measurement means.

[Supplementary Note 9]

An air current observation system including:
an air current detection means for generating, when an optical sensing device installed in a tower-like structure irradiates an aerial area in a periphery of the tower-like structure with laser light, and the optical sensing device receives reflected light corresponding to the laser light, air current information relating to an air current in the aerial area, based on the laser light and the reflected light; and
an air current map generation means for generating an air current map indicating a distribution of the air current in the aerial area by using the air current information.

[Supplementary Note 10]

The air current observation system according to supplementary note 9, wherein the air current detection means generates the air current information by detecting a wind direction and a wind velocity in the aerial area, based on a difference between a frequency component included in the laser light and a frequency component included in the reflected light.

[Supplementary Note 11]

The air current observation system according to supplementary note 9 or 10, wherein
the optical sensing device is installed in each of a plurality of the tower-like structures, and
the air current map generation means generates the air current map of a three-dimensional shape by using the air current information.

[Supplementary Note 12]

The air current observation system according to any one of supplementary notes 9 to 11, further including an output control means for outputting information including the air current map.

[Supplementary Note 13]

The air current observation system according to supplementary note 12, wherein the information including the air current map is output to an operation management system of a flying object, and used for computation of a recommended flight route in the aerial area.

[Supplementary Note 14]

The air current observation system according to supplementary note 12, wherein the information including the air current map is output to an environment measurement system, and used for measurement of an atmospheric environment in the aerial area.

[Supplementary Note 15]

The air current observation system according to any one of supplementary notes 9 to 11, further including:
a route computation means for computing a recommended flight route of a flying object in the aerial area by using the air current map; and
an output control means for outputting information including the recommended flight route.

[Supplementary Note 16]

The air current observation system according to any one of supplementary notes 9 to 11, further including:
an environment measurement means for measuring an atmospheric environment in the aerial area by using the air current map; and
an output control means for outputting information including a result of measurement by the environment measurement means.

[Supplementary Note 17]

An air current observation method including:
generating, by an air current detection means, when an optical sensing device installed in a tower-like structure irradiates an aerial area in a periphery of the tower-like structure with laser light, and the optical sensing device receives reflected light corresponding to the laser light, air current information relating to an air current in the aerial area, based on the laser light and the reflected light; and
generating, by an air current map generation means, an air current map indicating a distribution of the air current in the aerial area by using the air current information.

[Supplementary Note 18]

The air current observation method according to supplementary note 17, further including generating, by the air current detection means, the air current information by detecting a wind direction and a wind velocity in the aerial area, based on a difference between a frequency component included in the laser light and a frequency component included in the reflected light.

[Supplementary Note 19]

The air current observation method according to supplementary note 17 or 18, wherein
the optical sensing device is installed in each of a plurality of the tower-like structures, and
the air current observation method further comprises generating, by the air current map generation means, the air current map of a three-dimensional shape by using the air current information.

[Supplementary Note 20]

The air current observation method according to any one of supplementary notes 17 to 19, further including outputting, by an output control means, information including the air current map.

[Supplementary Note 21]

The air current observation method according to supplementary note 20, further including outputting the information including the air current map to an operation management system of a flying object, and using the information for computation of a recommended flight route in the aerial area.

[Supplementary Note 22]

The air current observation method according to supplementary note 20, further including outputting the information including the air current map to an environment measurement system, and using the information for measurement of an atmospheric environment in the aerial area.

[Supplementary Note 23]

The air current observation method according to any one of supplementary notes 17 to 19, further including:
computing, by a route computation means, a recommended flight route of a flying object in the aerial area by using the air current map; and
outputting, by an output control means, information including the recommended flight route.

[Supplementary Note 24]

The air current observation method according to any one of supplementary notes 17 to 19, further including:
measuring, by an environment measurement means, an atmospheric environment in the aerial area by using the air current map; and
outputting, by an output control means, information including a result of measurement by the environment measurement means.

[Supplementary Note 25]

A recording medium recording a program for causing a computer to function as:
an air current detection means for generating, when an optical sensing device installed in a tower-like structure irradiates an aerial area in a periphery of the tower-like structure with laser light, and the optical sensing device receives reflected light corresponding to the laser light, air current information relating to an air current in the aerial area, based on the laser light and the reflected light; and
an air current map generation means for generating an air current map indicating a distribution of the air current in the aerial area by using the air current information.

[Supplementary Note 26]

The recording medium according to supplementary note 25, wherein the air current detection means generates the air current information by detecting a wind direction and a wind velocity in the aerial area, based on a difference between a frequency component included in the laser light and a frequency component included in the reflected light.

[Supplementary Note 27]

The recording medium according to supplementary note 25 or 26, wherein
the optical sensing device is installed in each of a plurality of the tower-like structures, and
the air current map generation means generates the air current map of a three-dimensional shape by using the air current information.

[Supplementary Note 28]

The recording medium according to any one of supplementary notes 25 to 27, wherein the program causes the computer to function as an output control means for outputting information including the air current map.

[Supplementary Note 29]

The recording medium according to supplementary note 28, wherein the information including the air current map is output to an operation management system of a flying object, and used for computation of a recommended flight route in the aerial area.

[Supplementary Note 30]

The recording medium according to supplementary note 28, wherein the information including the air current map is output to an environment measurement system, and used for measurement of an atmospheric environment in the aerial area.

[Supplementary Note 31]

The recording medium according to any one of supplementary notes 25 to 27, wherein the program causes the computer to function as:
a route computation means for computing a recommended flight route of a flying object in the aerial area by using the air current map; and
an output control means for outputting information including the recommended flight route.

[Supplementary Note 32]

The recording medium according to any one of supplementary notes 25 to 27, wherein the program causes the computer to function as:
an environment measurement means for measuring an atmospheric environment in the aerial area by using the air current map; and
an output control means for outputting information including a result of measurement by the environment measurement means.

### REFERENCE SIGNS LIST

1 Tower-like structure
2 Optical sensing device
3 Air current observation device
4 Output device
11 Light emitting unit
12 Light receiving unit
21 Air current detection unit
22 Air current map generation unit
23 Output control unit
24 Route computation unit
25 Environment measurement unit
31 Computer
41 Processor
42 Memory
43 Processing circuit
100 Air current observation system
200 Operation management system
300 Environment measurement system

What is claimed is:

1. An air current observation device comprising:
at least one memory configured to store instructions; and at least one processor configured to execute the instructions to
generate, when an optical sensing device installed in a tower-like structure irradiates an aerial area in a periphery of the tower-like structure with laser light and the optical sensing device receives reflected light corresponding to the laser light, air current information relating to an air current in the aerial area, based on the laser light and the reflected light, and
generate an air current map indicating a distribution of the air current in the aerial area by using the air current information.

2. The air current observation device according to claim 1,
wherein the at least one processor generates the air current information by detecting a wind direction and a wind velocity in the aerial area, based on a difference between a frequency component included in the laser light and a frequency component included in the reflected light.

3. The air current observation device according to claim 1,
wherein the optical sensing device is installed in each of a plurality of the tower-like structures, and
the at least one processor generates the air current map of a three-dimensional shape by using the air current information.

4. The air current observation device according to claim 1,
wherein the at least one processor outputs information including the air current map.

5. The air current observation device according to claim 4,
wherein the information including the air current map is output to an operation management system of a flying object, and used for computation of a recommended flight route in the aerial area.

6. The air current observation device according to claim 4,
wherein the information including the air current map is output to an environment measurement system, and used for measurement of an atmospheric environment in the aerial area.

7. The air current observation device according to claim 1,
wherein the at least one processor computes a recommended flight route of a flying object in the aerial area by using the air current map; and
the at least one processor outputs information including the recommended flight route.

8. The air current observation device according to claim 1,
wherein the at least one processor measures an atmospheric environment in the aerial area by using the air current map; and
the at least one processor information including a result of measurement by the environment measurement means.

9. An air current observation system comprising:
at least one memory configured to store instructions; and at least one processor configured to execute the instructions to,
generate, when an optical sensing device installed in a tower-like structure irradiates an aerial area in a periphery of the tower-like structure with laser light and the optical sensing device receives reflected light corresponding to the laser light, air current information relating to an air current in the aerial area, based on the laser light and the reflected light, and
generate an air current map indicating a distribution of the air current in the aerial area by using the air current information.

10. The air current observation system according to claim 9,
wherein the at least one processor, generates the air current information by detecting a wind direction and a wind velocity in the aerial area, based on a difference between a frequency component included in the laser light and a frequency component included in the reflected light.

11. The air current observation system according to claim 9 or 10,
wherein the optical sensing device is installed in each of a plurality of the tower-like structures, and
the at least one processor generates the air current map of a three-dimensional shape by using the air current information.

12. The air current observation system according to claim 9,
wherein the at least one processor outputs information including the air current map.

13. The air current observation system according to claim 12,
wherein the information including the air current map is output to an operation management system of a flying object, and used for computation of a recommended flight route in the aerial area.

14. The air current observation system according to claim 12,
wherein the information including the air current map is output to an environment measurement system, and used for measurement of an atmospheric environment in the aerial area.

15. The air current observation system according to claim 9,
wherein the at least one processor computes a recommended flight route of a flying object in the aerial area by using the air current map; and
the at least one processor outputs information including the recommended flight route.

16. The air current observation system according to claim 9,
wherein the at least one processor measures an atmospheric environment in the aerial area by using the air current map; and
the at least one processor outputs information including a result of measurement by the environment measurement means.

17. An air current observation method comprising:
generating, by at least one memory configured to store instructions; and at least one processor configured to execute the instructions, when an optical sensing device installed in a tower-like structure irradiates an aerial area in a periphery of the tower-like structure with laser light and the optical sensing device receives reflected light corresponding to the laser light, air current information relating to an air current in the aerial area, based on the laser light and the reflected light; and
generating, by the at least one processor, an air current map indicating a distribution of the air current in the aerial area by using the air current information.

18. The air current observation method according to claim 17, further comprising generating, by the at least one processor, the air current information by detecting a wind direction and a wind velocity in the aerial area, based on a difference between a frequency component included in the laser light and a frequency component included in the reflected light.

19. The air current observation method according to claim 17, wherein the optical sensing device is installed in each of a plurality of the tower-like structures, and
the air current observation method further comprises generating, by the at least one processor, the air current map of a three-dimensional shape by using the air current information.

20. The air current observation method according to claim 17, further comprising outputting, by the at least one processor, information including the air current map.

21-24. (canceled)
